(19) United States
(12) Patent Application Publication
(10) Pub. No.: US 2011/0121504 A1
(43) Pub. Date: May 26, 2011

(54) NON-SLIP SPACER

(76) Inventors: Steve Donald Krohmer, Coon Rapids, MN (US); James R. Carroll, Maple Grove, MN (US); James Joseph Frey, Edina, MN (US); Daniel Patrick Banasik, Eagan, MN (US); Daniel L. Wenning, Minneapolis, MN (US)

(21) Appl. No.: 12/952,253

(22) Filed: Nov. 23, 2010

Related U.S. Application Data
(60) Provisional application No. 61/263,577, filed on Nov. 23, 2009.

(51) Int. Cl. B25B 11/00; B23P 11/00

(52) U.S. Cl. 269/289 R; 29/428

(57) ABSTRACT

A non-slip removable spacer for holding a workpiece in place relative to a work surface when interposed therebetween without permanent bonding therebetween. The spacer has a core with generally planar surfaces, with a pair elastomeric coverings applied to the surfaces. The elastomeric coverings do not fully cover the core, but leave exposed a peripheral edge of core to prevent shearing of the covering when lateral forces are applied to the workpiece. A method of assembly is also disclosed.

### CROSS-REFERENCE TO RELATED APPLICATION

This application is based on a provisional filing Ser. No. 61/263,577 filed 23 Nov. 2009 entitled NON-SLIP SPACER, which is also incorporated herein by reference.

### BACKGROUND

When using woodworking hand tools on a bench, a worker will often employ one or more clamps or a flexible non-skid pad or mat in an attempt to hold the workpiece in place while manipulating the workpiece with the tool (e.g., sanding, routing, etc.). A clamp can interfere with access to a workpiece and care must be taken not to mar the workpiece with the clamp. While such pads or mats may serve to constrain the workpiece from moving relative to the bench or tool, the workpiece rests on the pad or mat surface and therefore access to the workpiece by the tool from the sides, lower edges and workpiece bottom is inhibited. Using an interposing block has problems with slippage since. Increasing the friction without adhesives is possible but the material must not damage the workpiece so abrasives are out of the question. Soft materials are likely to shread because of the lateral shear forces applied to the workpiece when worked by a took (such as a sander or plane). A solution must provide a high degree of resistance, not mar the workpiece and be durable.

### SUMMARY

A spacer of the present disclosure includes a spacer body having two planar, opposed major surfaces. The spacer body is configured for elevating a workpiece above a work surface to create a clearance between the workpiece and the work surface. Each of the two opposed major surfaces includes a continuous, non-slip layer. The opposed major surfaces of the spacer may be symmetrical or asymmetrical in shape (e.g., round, square, oval, rectangular, pie-piece shaped, etc.).

Another aspect of the disclosure is A non slip removable spacer for holding a workpiece in place relative to a work surface when interposed therebetween a generally rigid core body having upper and lower generally planar surfaces a peripheral edge to each of said surfaces; an elastomer layer applied to said upper and lower surfaces and spaced from said peripheral edge to expose a portion of the planar surface around the extent of the elastomer; said elastomer being unitary resiliently compressible and having an exposed surface which is textured; bonding between the surfaces and the elastomer layer so that the spacer is a sandwich of hard generally planar core between to elastomer layers with a peripheral edge of said core

Another aspect of the disclosure is A method of constructing a non-slip spacer to prevent movement between a workpiece and a work surfaces without permanent affixation between the two comprising the steps of creating a core block with upper and lower generally planar surfaces; bonding a resilient, high friction elastomeric material to the upper and lower core surfaces; limiting the coverage of the upper and lower surfaces by the elastomer so that a peripheral edge of the core surrounds the elastomer.

This summary is not intended to identify key features or essential features of the disclosed subject matter, is not intended to describe each disclosed embodiment or every implementation of the disclosed subject matter, and is not intended to be used as an aid in determining the scope of the disclosed subject matter. Many other novel advantages, features, and relationships will become apparent as this description proceeds. The figures and the description that follow more particularly exemplify illustrative embodiments.

### DESCRIPTION OF THE FIGURES

The disclosed subject matter will be further explained with reference to the attached figures, wherein like structure is referred to by like reference numerals throughout the several views.

FIG. 1 is a perspective view of a prior art non-slip mat positioned on a work bench surface, having a workpiece disposed thereon with a router being positioned on the workpiece.

FIG. 2 is a perspective view of a plurality of exemplary non-slip spacers of the present disclosure.

FIG. 3 is a perspective view of a plurality of spacers according to FIG. 2, positioned on a work bench surface, having a workpiece laid thereupon, with the workpiece being worked upon by a router.

FIG. 4 is a perspective view of a plurality of spacers according to FIG. 2, positioned on a work bench surface, having a transparent workpiece laid thereupon (so that the non-slip spacers may be more easily seen), with the workpiece being worked on by a rotary surface finishing tool.

FIG. 5 is a perspective view of a plurality of non-slip spacers of the present disclosure elevating a surface of a large workpiece above a floor surface.

FIG. 6 illustrates a plurality of exemplary non-slip spacers of the present disclosure.

FIG. 7 is an enlarged perspective view of one of the spacers according to

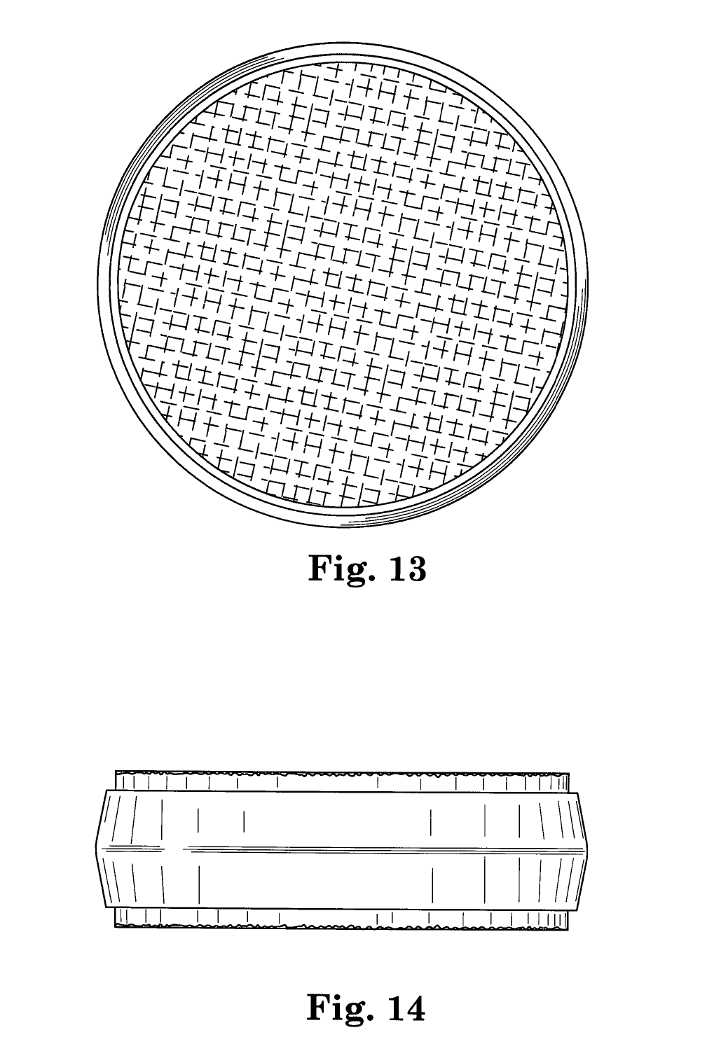

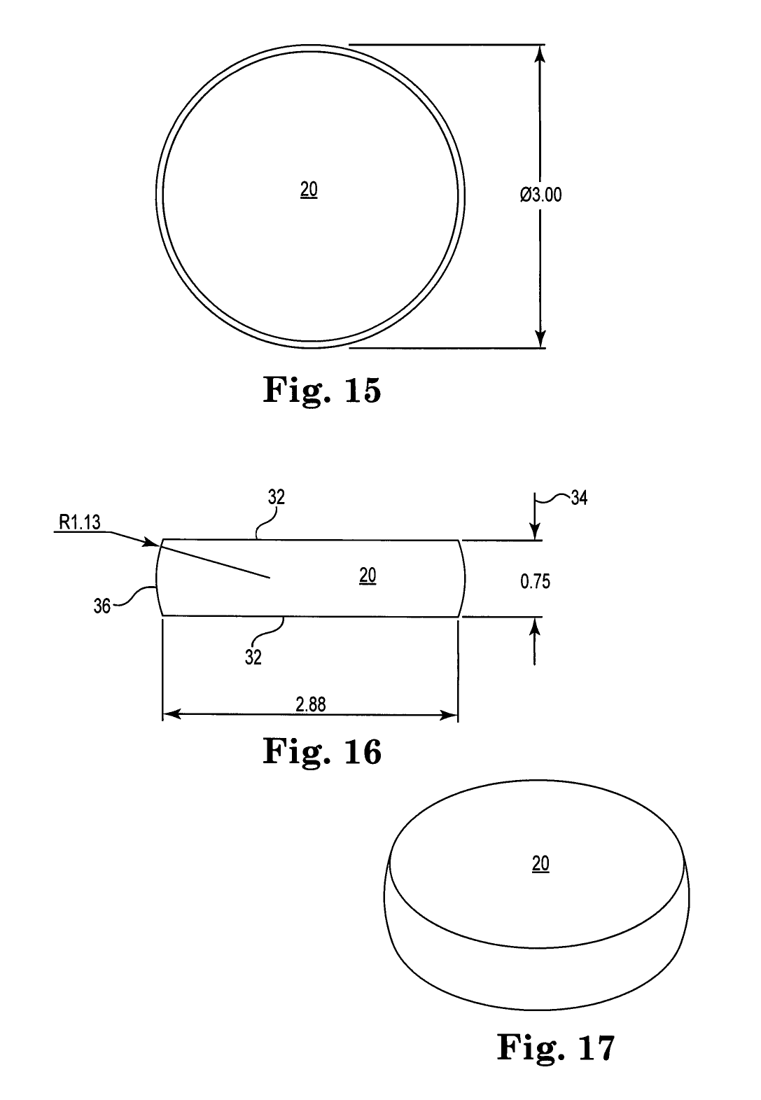

FIG. 6 positioned on a work bench surface, having a workpiece laid thereon, with the workpiece being worked on by a router.

FIG. 8 is a perspective view of a plurality of spacers according to FIG. 6, positioned on a work bench surface, having a workpiece laid thereon, with the workpiece being worked upon by a rotary sander.

FIG. 9 is a perspective view of a plurality of spacers according to FIG. 6, positioned on a work bench surface, having a workpiece laid thereon, with an upper surface of the workpiece being engaged by a manual carving tool.

FIG. 10 is a perspective view of a workpiece positioned on a work bench, supported by a plurality of spacers according to FIG. 6 (only one of which is shown), with a coating of surface treatment material (e.g., wood stain) being applied manually to the workpiece.

FIG. 11 is a perspective view of a workpiece positioned on a work bench, supported by a plurality of spacers according to FIG. 6 (only one of which is shown), with the workpiece being an upside down table top positioned for assembly of one of its legs thereto.

FIG. 12 is a perspective view of one of the spacers according to FIG. 6.

FIG. 13 is a top plan view of one of the spacers according to FIG. 6 (the bottom plan view is a mirror image of the top plan view).

FIG. 14 is a side elevation view of one of the spacers of FIG. 6 (the view from the side is the same on all sides thereof).

FIG. 15 is a top plan view of an exemplary spacer body for a spacer according to FIG. 6, showing an exemplary diameter.

FIG. 16 is a side elevation view of an exemplary spacer body for a spacer according to FIG. 6, showing exemplary dimensions.

FIG. 17 is a perspective view of an exemplary spacer body for a spacer according to FIG. 6.

FIGS. 18-28 illustrate additional exemplary major surface shapes for a spacer (or, in the case of FIGS. 19 and 20, for coordinated groups of spacers) of the present disclosure.

### DETAILED DESCRIPTION

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

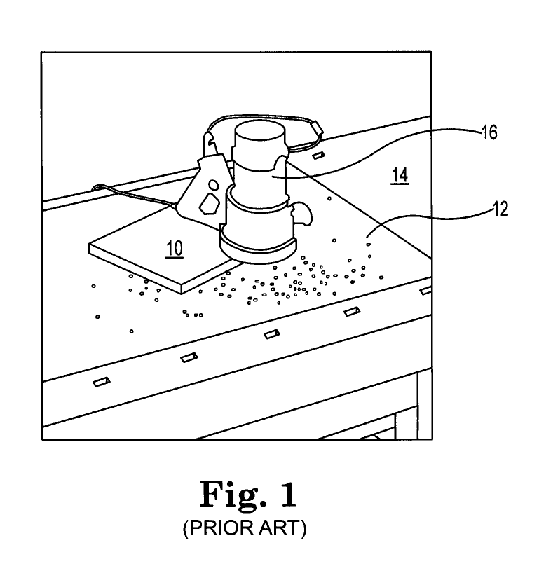

As shown in FIG. 1, workpiece 10 rests on prior art non-slip mat 12, which in turn rests on work bench surface 14. Typically, such non-slip mats have a uniform thickness, ranging from 0.125 to 0.25 inch. A hand tool such as router 16 has limited access to the side edges and bottom surfaces of workpiece 10 in the illustrated arrangement, since the workpiece 10 is spaced from the work bench surface 14 only by the thickness of the non-slip mat 12, and the mat 12 may extend out from the sides of the workpiece 10.

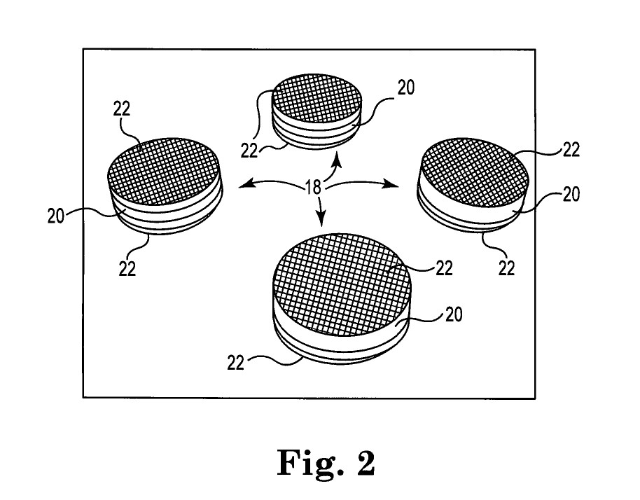

The present disclosure is directed to a non-skid spacer arrangement and methods for its use. In an exemplary embodiment such as shown in FIG. 2, each of a plurality of spacers 18 comprises a spacer body 20 sandwiched between non-slip layers 22.

In an exemplary embodiment, spacer body 20 is made of a hard, incompressible and durable material such as wood or plastic. In one illustrated embodiments, each spacer body 20 is configured as a disc so its opposed major surfaces are circular, though other shapes for spacer major surfaces may also be used, as further discussed below.

In one exemplary embodiment, non-slip layer 22 is disposed on each of the two major surfaces of the spacer body 20. Non-slip layer 22 may be composed of a durable, yet compressible, material such as rubber, silicone, a thermoplastic elastomer, or the like, with a nominal generally uniform thickness of 0.14 inch. An acceptable range for the non-slip layer thickness is 0.0625 to 0.50 inch. In one embodiment, the side of the non-slip layer 22 opposite the side that is attached to spacer body 20 is textured (see, e.g., FIG. 2, 6 or 12-14). Non-slip layers 22 may be attached to each of the two opposed major surfaces of spacer body 20 by an adhesive, though other attachment means and mechanisms can be used.

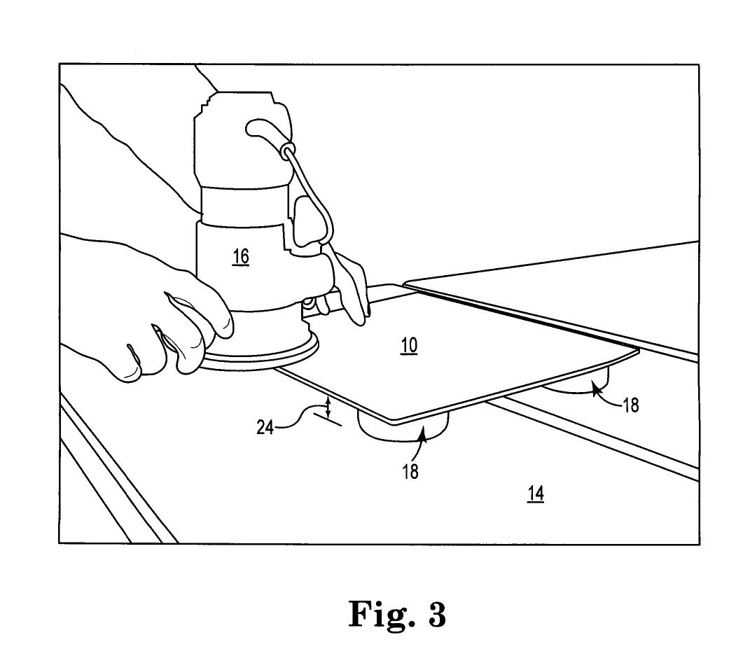

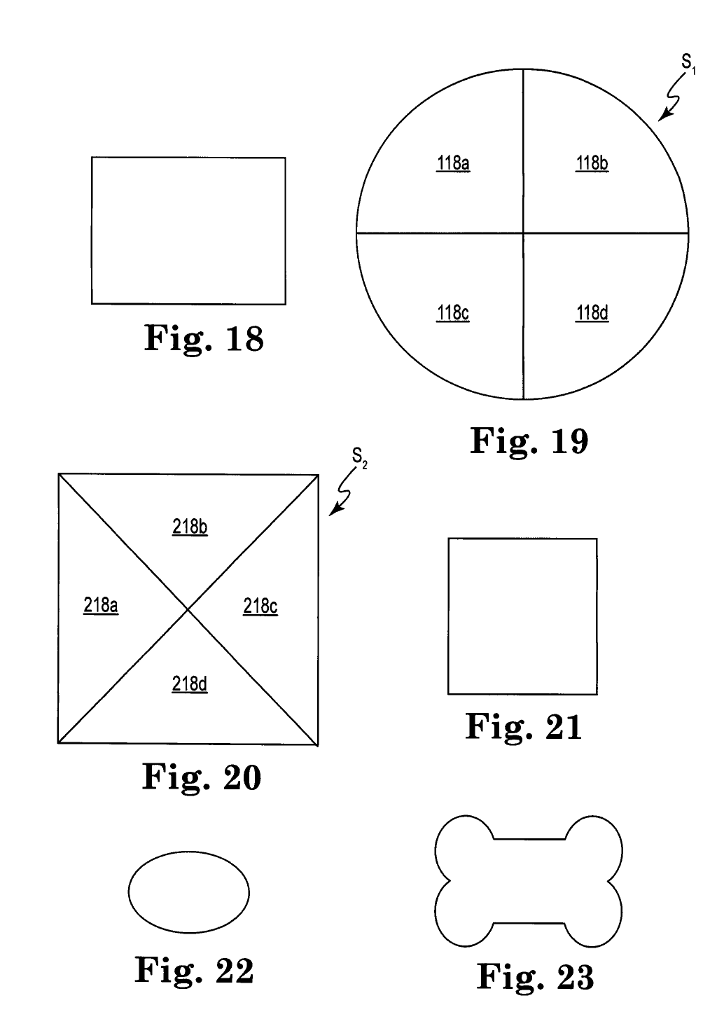

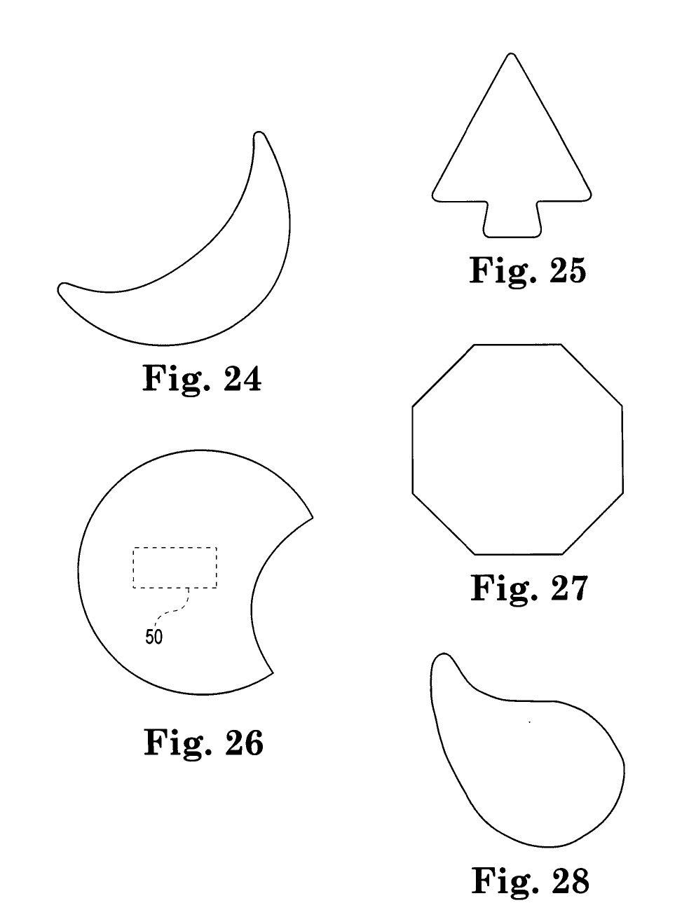

FIG. 3 is a perspective view of a workpiece 10 resting upon a plurality of non-slip spacers 18, which in turn rest upon work bench surface 14. The thickness of non-slip spacers 18 elevates workpiece 10 by a clearance distance 24 above work bench surface 14. Thus, the user of a hand-held woodworking tool such as router 16 is able to access the side and bottom edges of workpiece 10 without contacting the work bench surface 14 with the router 16. This is useful, for instance, when the depth of a tool (e.g., a router bit) is greater than the thickness of the workpiece, such as illustrated in FIG. 7.

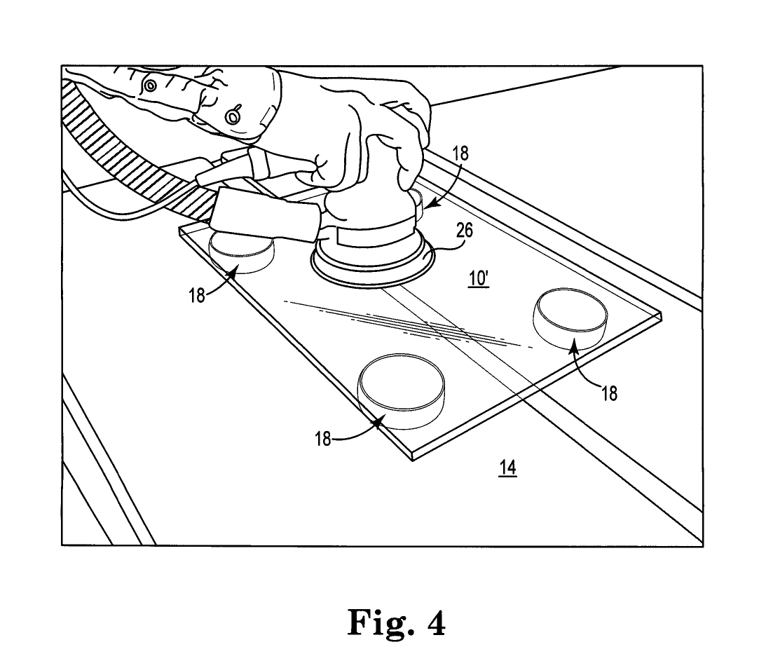

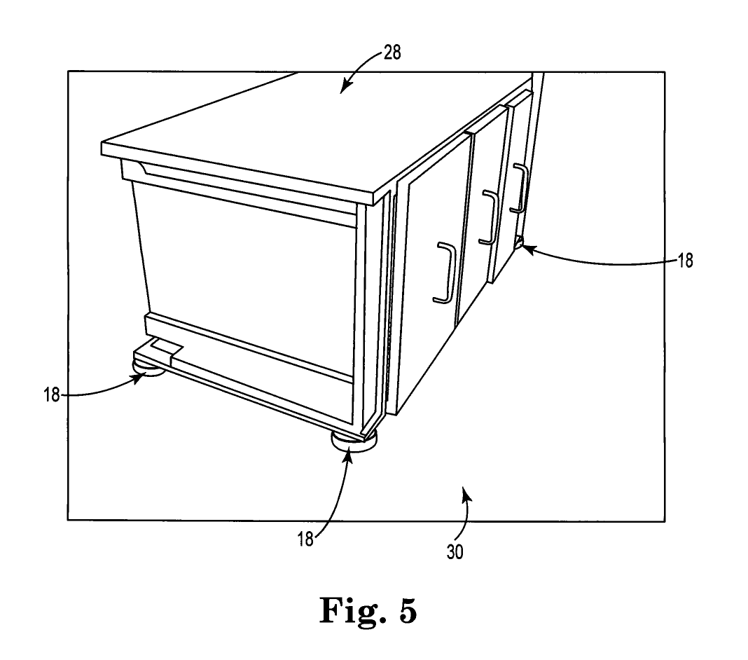

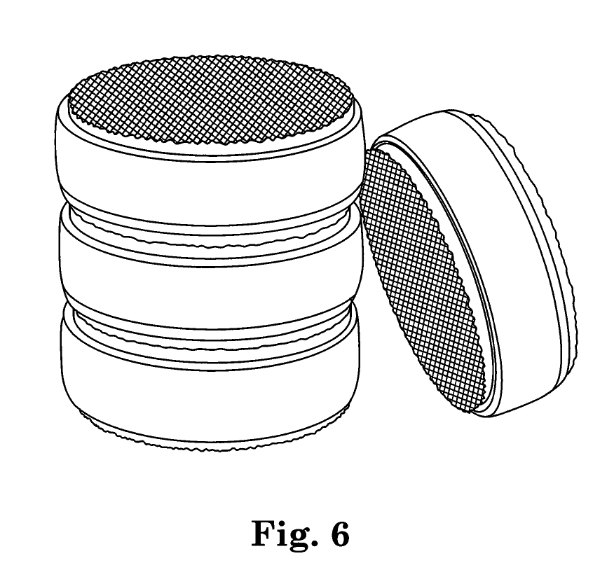

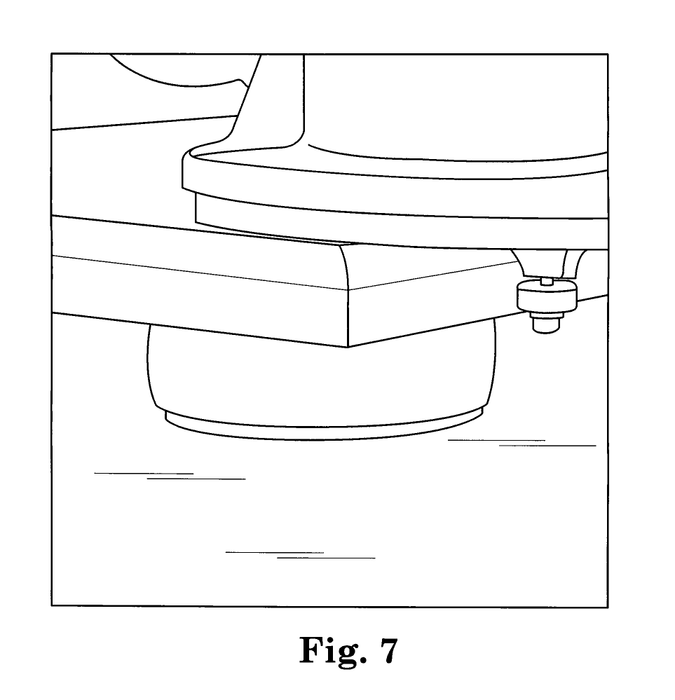

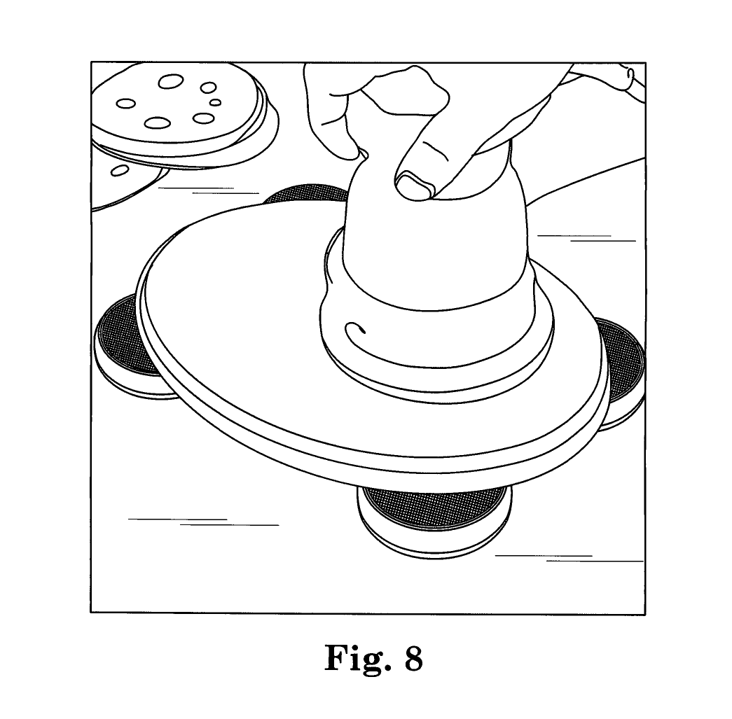

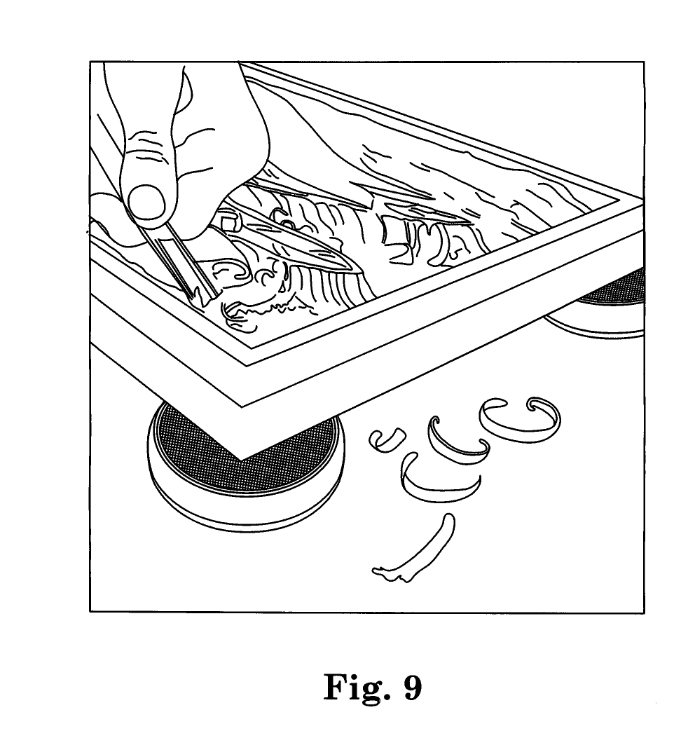

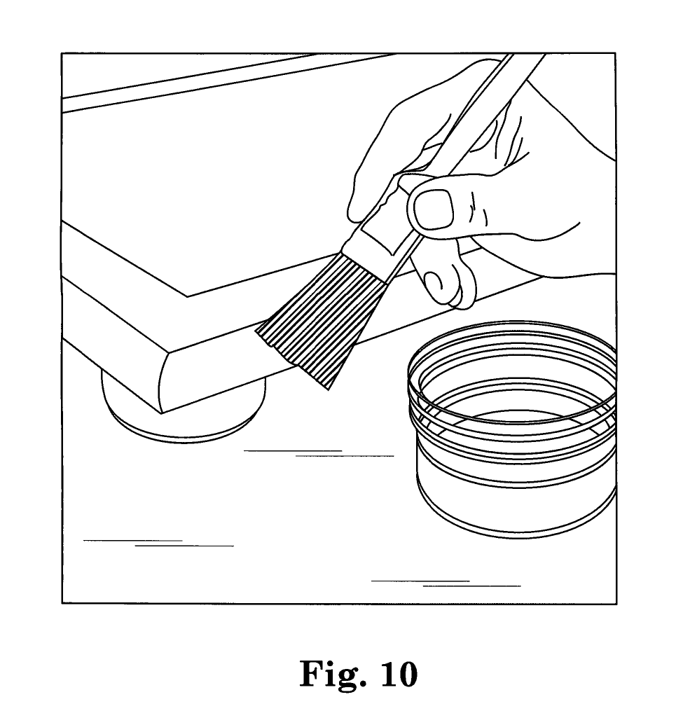

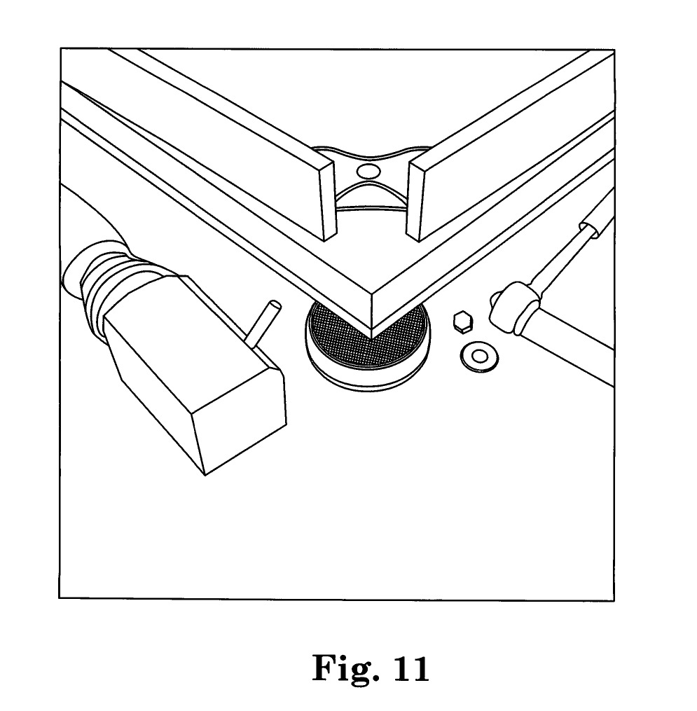

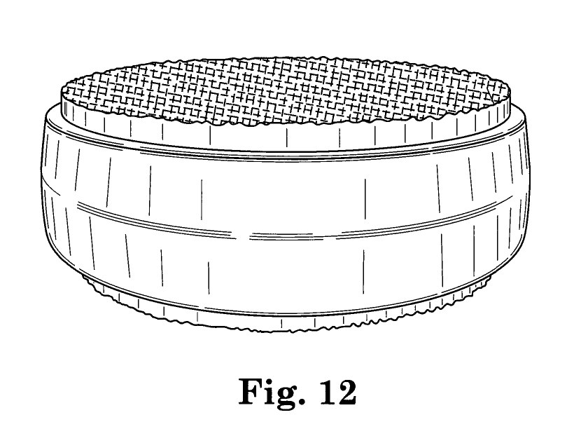

FIG. 4 is a view similar to FIG. 3, but showing transparent workpiece 10′ and a different woodworking hand tool 26, such as a sander, buffer or polisher. A plurality of non-slip spacers 18 is arranged under workpiece 10′ to support workpiece 10′ as it is worked upon by hand tool 26. While four non-slip spacers 18 are shown in these illustrations, it is to be understood that more or fewer may be used, depending on the size and shape of the workpiece 10, 10′. In an exemplary method of use, each non-slip spacer 18 is positioned entirely between workpiece 10, 10′ and work bench surface 14. However, such placement is not necessary and non-slip spacers 18 will adequately support workpiece 10, 10′ even if a portion of a non-slip spacer 18 projects beyond workpiece 10, 10′ (see, e.g., FIGS. 5, 8, 9 and 11).

The use of a plurality of non-slip spacers 18 allows for flexibility in the arrangement of non-slip spacers 18 relative to work bench surface 14 and workpiece 10, 10′. For example, more or fewer non-slip spacers 18 may be used under a particular workpiece 10, 10′. Moreover, the plurality of non-slip spacers 18 may be disposed in an arrangement that is symmetrical or asymmetrical with respect to workpiece 10, 10′ and/or the spacers 18 themselves, depending upon the particular application. Moreover, individual non-slip spacers 18 may be easily repositioned as needed while the worker works upon workpiece 10, 10′.

FIG. 5 shows an alternative method of use of non-slip spacers 18, in which they are positioned beneath a large workpiece 28 to elevate workpiece 28 above a floor surface 30. The spacers are also useful for protecting a surface of a workpiece from being marred by contact with a floor or rough workpiece surface, as illustrated in FIG. 5 and FIG. 11 (for example, FIG. 11 illustrates a finished table top surface spaced from a rough workpiece surface by spacers).

FIGS. 15, 16 and 17, respectively, are top, side elevation and perspective views of an exemplary spacer body 20. As shown in FIG. 15, such a spacer body 20 has a round major surface with a diameter of about 3 inches. As shown in FIG. 16, spacer body 20 has a diameter at each major surface 32 of about 2.88 inches. In an exemplary embodiment, spacer body 20 has a thickness 34 of 0.75 inch. In the illustrated embodiment, outer radial wall 36 has a radius of curvature of about 1.13 inch. Based the numbers provided above, the elastomer thickness is preferably about 5.7%, 18% or 37.5% of the core thickness.

As noted above, the major surfaces of a spacer can have a variety of shapes. FIGS. 18-28 are merely some examples of the alternative shapes that can be used for the major surfaces of the non-slip spacers of the present disclosure. FIG. 18 illustrates an exemplary rectangular shape. FIG. 19 illustrates four spacers 118a, 118b, 118c and 118d, each of which has major surfaces thereon shaped as a quarter of a circle (i.e., a pie-piece shape). The four quarters 118a, 118b, 118c and 118d can be joined to form a combined large circular horizontal spacer assembly S₁. Another example of this type of horizontal spacer assembly is illustrated in FIG. 20. FIG. 20 shows spacers 218a, 218b, 218c and 218d, each with isosceles triangular major surface shapes. The spacers 218a, 218b, 218c and 218d can be joined into a spacer assembly S₂ which is rectilinear (in the illustrated example, square). FIG. 21 illustrates a single spacer major surface formed in a square shape. FIG. 22 illustrates a spacer major surface having an oval shape. FIG. 23 illustrates a spacer major surface having a dog bone shape. FIG. 24 illustrates a spacer major surface having a moon sliver shape. FIG. 25 illustrates a spacer major surface having a Christmas tree shape. FIG. 26 illustrates a round “cookie” shaped major surface shape with a bite out of it. FIG. 27 illustrates an octagon shaped major surface for a spacer. FIG. 28 illustrates a tear or paisley shaped major surface for a spacer. Again, the major surface shapes illustrated herein are exemplary.

In some application, it may be desirable to have a spacer which is longer in one dimension than in another (such as illustrated, for example, by the spacer shapes of FIGS. 18, 22, 23, 24, 25 and 28). This may provide additional stability and/or gripping surface and force along the elongated dimension of the spacer.

A rare earth magnet, such as illustrated by magnet 50 in FIG. 26, may be adhered to, embedded in or encased within a spacer. This magnet would then have a strong enough magnetic attraction along at least one major surface of that space to allow the spacer to be attached to a ferrous vertical surface, such as the side of a steel tool cabinet, steel work bench leg, or the like. This features facilitates ease of storage and accessibility for the spacer of the present disclosure.

In some instances, it may be also be useful to stack spacers to further space a workpiece from a work surface. For example, eight spacers could be used to form four vertical spacer assemblies for use in spacing a workpiece from a work surface, with each vertical spacer assembly composed of two spacers stacked together (in the manner of the stacked spacers illustrated in FIG. 6).

As illustrated in FIGS. 7 and 8, the work bench environment is not always a clean one—there may be debris or dust or sawdust there. However, the non-slip spacer of the present disclosure still provides a relatively non-slip surface even if there is a layer of sawdust between the spacer and the work bench, or between the spacer and the workpiece. It is believed that this attribute is facilitated by the fact that the non-slip layers 22 are compressible and textured.

It is also believed, that providing a peripheral edge around the elastomer and by providing a smooth or sharp and continuous straight edge on the elastomer, as shown in the drawings is the preferred embodiment. The elastomer is preferably limited in its extend to not overlying the entire core surface. This protects the elastomer from shearing when the lateral forces of the workpiece vs workbench/surfaces are applied. The elastomer will be driven toward the core but if it were to stretch beyond the core, it might be shear away and disintegrate. Because the peripheral edge supplies support for the stretched elastomer, it stays intact. Further, if the edge of the elastomer forms a continuous unbroken straight edge, such as forming a straight line edge or sidewall, there is greater cohesion and the elastomer is less likely to ‘break up” into pieces. Such pieces then become a roller bearing surface which would reduce the gripping force.

The elastomer shown is unitary, ie made of a single material, not an elastomer with a web overlay. Such alternative will provide lower frictional engagement.

The non-slip spacer of the present disclosure lifts, grips and protects the workpiece while it is being worked on. Each major surface of the non-slip spacer of the present disclosure has a high-friction resilient surface. Each spacer also has a durable core. The spacers constrain workpieces from slipping while routing, sanding, carving and the like. The spacers raise up panels for edge work and finishing, and make assembly easier. Set up of the spacers on a work bench can be done quickly, and the spacers are quite versatile in terms of both horizontal and vertical configurations. Using the spacers of the present invention provides the ability to route, sand, cut and carve a workpiece without using clamps, allows a workpiece to be raised up for easy edge finishing, allows the support of a workpiece without leaving marks on the workpiece, allows the assembly of a workpiece or project on a stable, non-slip base, and allows for a quick setup for any application.

Although the non-slip spacers disclosed herein have been described with respect to several embodiments, workers skilled in the art will recognize that changes may be made in form and detail without departing from the spirit and scope of the non-slip spacer disclosure.

1. A non slip removable spacer for holding a workpiece in place relative to a work surface when interposed therebetween comprising:
a. a generally rigid core body having upper and lower generally planar surfaces a peripheral edge to each of said surfaces;
b. an elastomer layer applied to said upper and lower surfaces and continuous unbroken straight edge which is spaced from said peripheral edge to expose a portion of the planar surface around the extent of the elastomer; said elastomer being unitary resiliently compressible and having an exposed surface which is textured;
c. bonding between the surfaces and the elastomer layer so that the spacer is a sandwich of hard generally planar core between to elastomer layers with a peripheral edge of said core

2. The spacer of claim 1 wherein said exposed peripheral edge has a width not less than the height of the elastomer layer.

3. The spacer of claim 1 wherein said textured surface is uneven and high friction.

4. The spacer of claim 1 wherein said core is generally cylindrical.

5. The spacer of claim 1 wherein said elastomer is a unitary material.

6. The spacer of claim 1 wherein said core includes a magnet.

7. The spacer of claim 1 wherein the elastomer thickness is approximately 18% of the to core thickness.

8. The spacer of claim 1 wherein the elastomer thickness is approximately 5.7% of the to core thickness

9. The spacer of claim 1 wherein the elastomer thickness is approximately 37.5% of the to core thickness.

10. A non slip removable spacer for holding a workpiece in place relative to a work surface when interposed therebetween without permanent bonding therebetween comprising:
a. a generally rigid incompressible core body having upper and lower generally planar surfaces a peripheral edge to each of said surfaces;
b. a compressible elastomer layer having continuous unbroken straight edges said elastomer being applied to said upper and lower surfaces and spaced from said peripheral edge to expose a portion of the planar surface around the extent of the elastomer; said elastomer being unitary resiliently compressible and having an exposed surface which is textured;
c. permanent bonding between the surfaces and the elastomer layer so that the spacer is a sandwich of hard generally planar core between to elastomer layers with a peripheral edge of said core

11. A method of constructing a non-slip spacer to prevent movement between a workpiece and a work surfaces without permanent affixation between the two comprising the steps of:
creating a core block with upper and lower generally planar surfaces;
bonding a resilient, high friction elastomeric material to the upper and lower core surfaces;
cutting the edges of the elastomeric material so that they form straight and unbroken sidewalls;
limiting the coverage of the upper and lower surfaces by the elastomer so that a peripheral edge of the core surrounds the elastomer.

12. The method of claim 11 wherein the peripheral edge surrounds the elastomer on all sides.

13. The method of claim 11 wherein the elastomer is a unitary material.

14. The method of claim 11 further including the step of setting the percentage of elastomer thickness to core thickness at approximately 18%.

15. The method of claim 11 further including the step of setting the percentage of elastomer thickness to core thickness at approximately 5.7%.

16. The method of claim 11 further including the step of setting the percentage of elastomer thickness to core thickness at approximately 37.5%.
